(19) United States
(12) Patent Application Publication
(10) Pub. No.: US 2016/0345393 A1
(43) Pub. Date: Nov. 24, 2016

(54) FISHING LIGHT SYSTEM

(71) Applicant: GENIUS ELECTRONIC OPTICAL CO., LTD., TAICHUNG CITY (TW)

(72) Inventors: YUNG-HAN LAI, TAICHUNG CITY (TW); CHAO-KUN HUANG, TAICHUNG CITY (TW); CHIH-SHEN LIN, TAICHUNG CITY (TW)

(73) Assignee: Genius Electronic Optical Co., Ltd

(21) Appl. No.: 15/150,033

(22) Filed: May 9, 2016

(30) Foreign Application Priority Data
May 20, 2015 (TW) 104115992

(51) Int. Cl. H05B 33/08; A01K 97/00

(52) U.S. Cl. CPC H05B 33/089; H05B 33/0845; A01K 97/00

(57) ABSTRACT

A fishing light system includes: an alternating current power source, a power supply device electrically connected to the alternating current power source, and a light emitting diode fishing lamp electrically connected to the power supply device. The LED fishing lamp is used in combination with the power supply device which is capable of converting alternating current into a power supply which a voltage peak value and a voltage valley value. Since the power supply device is not needed to covert alternating current into direction current, there is no need for the power supply device to be equipped with a coil transformer, which consequently reduces the volume, weight and cost of the fishing light system of the present invention.

### BACKGROUND

1. Field of the Invention

The present invention relates to a fishing light, and more particularly to a fishing light system.

2. Related Prior Art

Organisms with positive phototaxis will be affected by ambient light and move toward the direction of light Source. Fish light is such a device attached to a fishing boat used to attract fish at night by taking advantage of phototaxis.

Fish lights normally use filament lamps as light source, and filament lamps have the disadvantages of inadequate concentration of light. Therefore, a lot of filament lamps are required in order to provide sufficient brightness, which consequently causes the problem of high energy consumption and considerable fuel cost.

Therefore, LEDs are used as fishing lights to attract fish. However, LED lamps are DC driven, and the power source for the LED fishing lamps normally comes from the generator on the fishing boat. The generator generates AC power, and therefore, a AC/DC transformer is required. However, the AC/DC transformer is large and heavy, and therefore inconvenient to use.

The present invention has arisen to mitigate and/or obviate the afore-described disadvantages.

### SUMMARY

The present invention is aimed at providing a fishing light system which overcomes the disadvantage that the conventional LED fishing lamp has to be equipped with a transformer which has a large size and heavy weight.

Therefore, a fishing light system in accordance with the present invention comprises:

an alternating current power source for generating alternating current;

a power supply device electrically connected to the alternating current power source and capable of converting the alternating current into a power supply that has a voltage peak value and a voltage valley value, wherein the voltage peak value is greater than the voltage valley value; and

a light emitting diode fishing lamp electrically connected to the power supply device, so that the power supply device supplies power to the light emitting diode fishing lamp.

The LED fishing lamp of the present invention is used in combination with the power supply device which is capable of converting alternating current into a power supply which a voltage peak value and a voltage valley value. Since the power supply device is not needed to covert alternating current into direction current, there is no need for the power supply device to be equipped with a coil transformer, which consequently reduces the volume, weight and cost of the fishing light system of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a block diagram showing a fishing light system in accordance with the preferred embodiment of the present invention;

FIG. 2 is a flow chart view illustrating the operation of the fishing light system in accordance with the preferred embodiment of the present invention;

FIG. 3 shows the wave form of the alternative current outputted from the AC power source of the fishing light system in accordance with the preferred embodiment of the present invention; and

FIG. 4 shows the wave form of the alternative current outputted from the power supply of the fishing light system in accordance with the preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

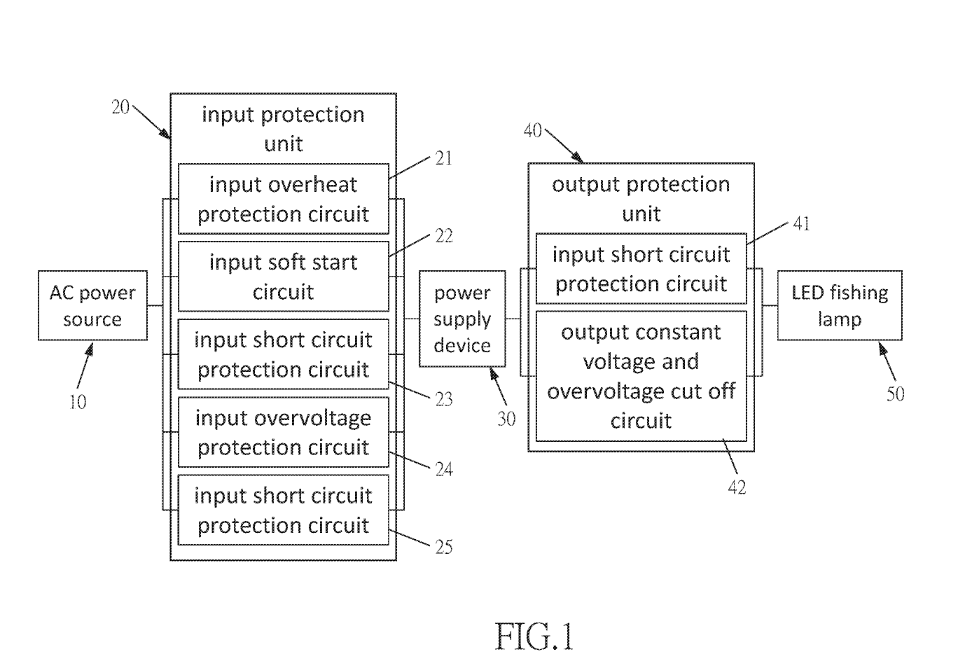

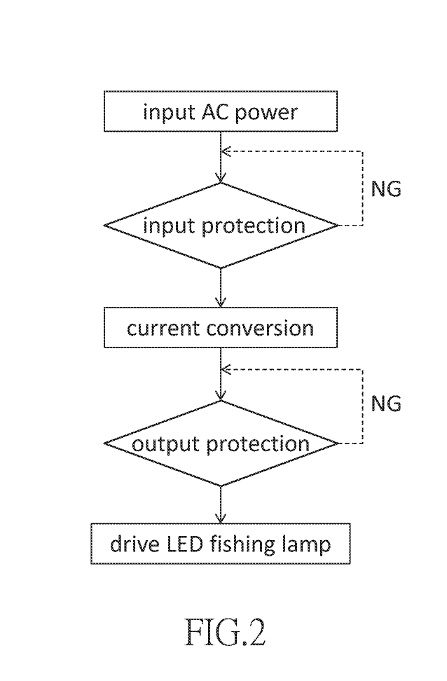

Referring to FIGS. 1-4, the fishing light system in accordance with the preferred embodiment of the present invention comprises: an AC power source 10, an input protection unit 20, a power supply device 30, an output protection unit 40, and an LED fishing lamp 50.

The AC power source 10 is three-phase alternating current generated by a generator.

The input protection unit 20 includes: an input overheat protection circuit 21, an input soft start circuit 22, an input short circuit protection circuit 23, an input overvoltage protection circuit 24, and an input voltage regulation circuit 25.

The input overheat protection circuit 21 is used to turn off the AC power source 10 when the temperature of the input protection unit 20 reaches to a predetermined value.

The input overvoltage protection circuit 24 is used to turn off the AC power source 10 when the voltage of the AC power source 10 reaches to a predetermined value.

The input voltage regulation circuit 25 is used to regulate the voltage outputted from the input protection unit 20.

The power supply device 30 is electrically connected to the input overheat protection circuit 21, the input soft start circuit 22, the input short circuit protection circuit 23, the input overvoltage protection circuit 24, and the input voltage regulation circuit 25 of the input protection unit 20, so that electric connection is established between the power supply device 30 and the AC power source 10. The power supply device 30 converts the alternating current outputted from the AC power source 10 into a power supply that has a voltage peak value and a voltage valley value, and the voltage peak value is greater than the voltage valley value.

The output protection unit 40 includes: an output short circuit protection circuit 41, and an output constant voltage and overvoltage cut off circuit 42 which are electrically connected to the power supply device 30.

The output short circuit protection circuit 41 is used to break the circuit when the voltage outputted from the power supply device 30 reaches or surpasses a predetermined amount.

The LED fishing lamp 50 is electrically connected to the output short circuit protection circuit 41, and an output constant voltage and overvoltage cut off circuit 42, respectively, so that electric connection is established between the LED fishing lamp 50 and the power supply device 30, and as a result, the power supply device 30 can supply power to the LED fishing lamp 50 to drive the same.

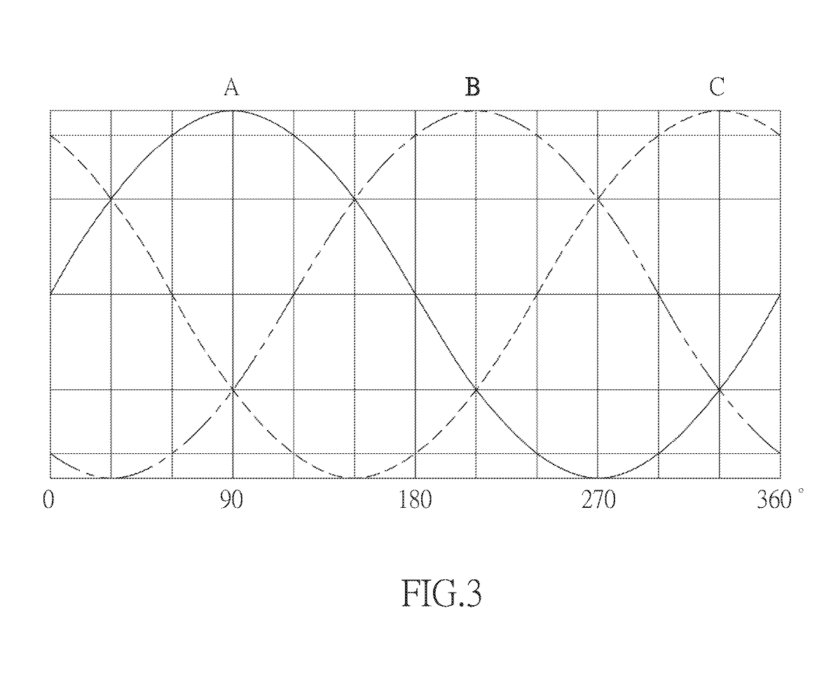

The fishing light system of the present invention is used on a fishing boat, and therefore the AC power outputted from the generator of the fishing boat can be used as the AC power source 10 of the fishing light system. The AC power source 10 provides AC power to the input protection unit 20. The AC power source 10 of this embodiment is three-phase AC, and the wave form of the alternating current is shown in FIG. 3. When the AC current flows through the input protection unit 20, the input overheat protection circuit 21 checks the AC current and will turn off the AC power source 10 when detecting that the temperature of the input protection unit 20 is higher than a predetermined value.

The input short circuit protection circuit 23 monitors the current flowing through the input protection unit 20 and will break the circuit when detecting a short circuit.

The input overvoltage protection circuit 24 will create a circuit break when detecting that the voltage of the input protection unit 20 is higher than a predetermined value.

The input voltage regulation circuit 25 is used to regulate the voltage outputted from the input protection unit 20 to a predetermined value.

The input soft start circuit 22 of the input protection unit 20 is capable of controlling the delay time of the AC current outputted from the input protection unit 20 as desired.

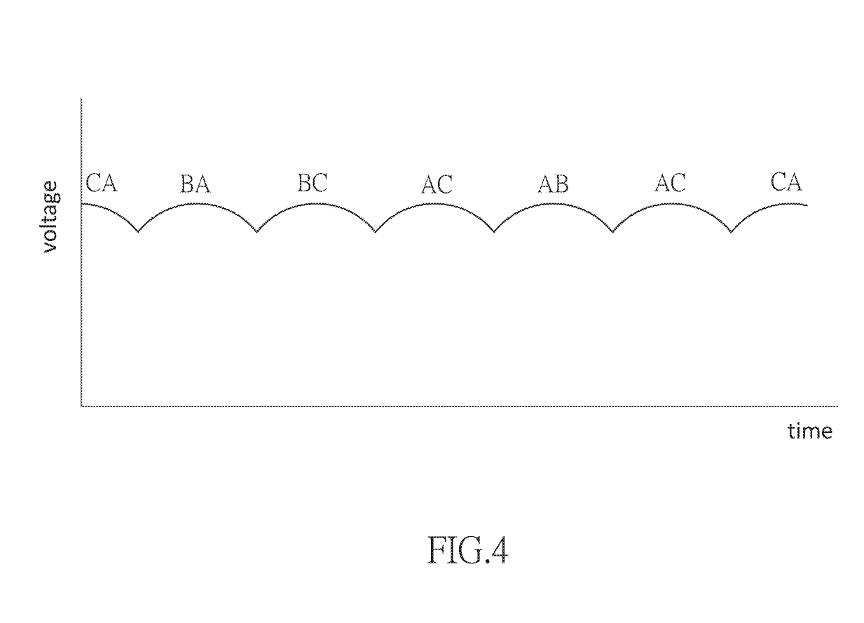

The abovementioned predetermined values of the respective circuits of the input protection unit 20 are set at a level appropriate to drive the LED fishing lamp 50. When AC current is able to flow through the input protection unit 20, it represents that the AC current is qualified. The AC current continues to flow to the power supply device 30 after flowing through the input protection unit 20, and after flowing through the power supply device 30, the AC current will be transformed into the power supply which has a voltage peak value and a voltage valley value, as shown in FIG. 4. Thus, the invention does not need to convert alternating current to direct current whose voltage change does not change at all. Therefore, the volume and weight of the power supply device 30 of the present invention can be reduced without the use of coil transformer.

After the power supply device 30 converts AC current into the power supply, the power supply is outputted the power supply device 30 and then must flow through the output protection unit 40 before being supplied to the LED fishing lamp 50. When the power supply flows through the output protection unit 40, the output short circuit protection circuit 41 of the output protection unit 40 can ensure that the current flowing through the output protection unit 40 is no greater than the predetermined value. The output constant voltage and overvoltage cut off circuit 42 can ensure that the voltage of the output protection unit 40 is smaller than the predetermined value. After flowing through the output protection unit 40, the power supply will be supplied to and drive the LED fishing lamp 50.

The power supply device 30 can convert AC current into the power supply which is supplied to drive the LED fishing lamp 50, and therefore, the volume, weight and the cost of the power supply drive 30 are reduced.

Since the power supply for driving the LED fishing lamp 50 has the voltage valley which is smaller than DC voltage, it can reduce the energy consumption and cost, while increasing the added value of the products.

Besides, the current of the present invention for driving the LED fishing lamp 50 has to go through the repeated detection by the input protection circuit 20 and the output protection circuit 40, which ensures that the current for driving the LED fishing lamp 50 is the most appropriate, thus reducing the damage to the LED fishing lamp 50, extending the life the LED fishing lamp 50, and reducing maintenance cost.

While we have shown and described various embodiments in accordance with the present invention, it is clear to those skilled in the art that further embodiments may be made without departing from the scope of the present invention.

What is claimed is:

1. A fishing light system, comprising:
an alternating current power source for generating alternating current;
a power supply device electrically connected to the alternating current power source and capable of converting the alternating current into a power supply that has a voltage peak value and a voltage valley value, wherein the voltage peak value is greater than the voltage valley value; and
a light emitting diode fishing lamp electrically connected to the power supply device, so that the power supply device supplies power to the light emitting diode fishing lamp.

2. The fishing light system as claimed in claim 1, wherein the alternating current power source is three-phase alternating current.

3. The fishing light system as claimed in claim 1 further comprising an input protection unit electrically connected between the alternating current power source and the power supply device, and the input protection unit includes an input overheat protection circuit which is used to turn off the alternating current power source when a temperature of the input protection unit reaches to a predetermined value.

4. The fishing light system as claimed in claim 1 further comprising an input protection unit electrically connected between the alternating current power source and the power supply device, and the input protection unit includes an input soft start circuit.

5. The fishing light system as claimed in claim 1 further comprising an input protection unit electrically connected between the alternating current power source and the power supply device, and the input protection unit includes an input short circuit protection circuit.

6. The fishing light system as claimed in claim 1 further comprising an input protection unit electrically connected between the alternating current power source and the power supply device, and the input protection unit includes an input overvoltage protection circuit which is used to turn off the alternating current power source when a voltage of the alternating current power source reaches to a predetermined value.

7. The fishing light system as claimed in claim 1 further comprising an input protection unit electrically connected between the alternating current power source and the power supply device, and the input protection unit includes an input voltage regulation circuit which is used to regulate a voltage outputted from the input protection unit.

8. The fishing light system as claimed in claim 1 further comprising an output protection unit electrically connected between the power supply device and the light emitting diode fishing lamp, and the output protection unit includes an output short circuit protection circuit.

9. The fishing light system as claimed in claim 1 further comprising an output protection unit electrically connected between the power supply device and the light emitting diode fishing lamp, and the output protection unit includes an output constant voltage and overvoltage cut off circuit.
